(19) United States
(12) Patent Application Publication
(10) Pub. No.: US 2011/0189640 A1
(43) Pub. Date: Aug. 4, 2011

(54) System, Method, and Apparatus for Detecting Body Fillers Used to Repair Damaged Automotive Sheet Metal

(76) Inventor: William David Hurd, Evans, GA (US)

(21) Appl. No.: 13/020,632

(22) Filed: Feb. 3, 2011

Related U.S. Application Data
(60) Provisional application No. 61/300,978, filed on Feb. 3, 2010.

(51) Int. Cl. G09B 19/00; G01N 27/72

(52) U.S. Cl. 434/219; 324/226

(57) ABSTRACT

Disclosed is a body panel inspection device that may be used to determine if a vehicle was in an accident. The inspection device uses a magnet with a particular magnetic strength and other characteristics in order to more accurately determine if a vehicle body panel has been damaged and subsequently repaired through use of non-ferrous filler materials. Also disclosed is a vehicle inspection kit carrying the disclosed magnetic inspection device and further including a method of vehicle inspection by use of the disclosed kit.

### CROSS-REFERENCE TO RELATED APPLICATION

This application claims priority under 35 U.S.C. § 119(e) to U.S. provisional application Ser. No. 61/300,978, filed on Feb. 3, 2010, entitled “System, Method, and Apparatus for Detecting Body Fillers Used to Repair Damaged Automotive Sheet Metal,” which is herein incorporated by reference in its entirety.

### TECHNICAL FIELD

The technical field relates, generally, to inspection systems for used automobiles and, more particularly, to automobile inspection systems for used automobiles featuring novel magnetic means for detecting body panel repairs.

### BACKGROUND

Consumers who desire to buy a used car usually wish to save money. Buying a used car affords a consumer the opportunity to get the most features for the least amount of money. Buying a used car, however, has its risks.

Because a used car has been driven by someone else, consumers cannot fully know how well such a used car has been cared for and maintained. While it is sometimes true that a vehicle history report can be obtained, delays in reporting information related to a particular vehicle can sometimes take in excess of eight (8) months. In such cases, a buyer may make a purchase decision in reliance upon a report that may be dramatically outdated. Even if the report's contents are relatively timely, information such as whether the title is a salvage title or whether the odometer has been rolled back does not give a complete and accurate picture of the used car's history and probable future serviceability.

Furthermore, vehicle history reports sometimes do not provide certain categories of information. For example, damage to a vehicle occurring during transportation from manufacturer to dealer may not be reported. Furthermore, people frequently do not report accidents, weather-related damage, or the like, because of large deductibles, lack of insurance, or the fear of a payment increase in their car insurance policy. In addition, many people neglect to change their oil and complete other manufacturer-suggested maintenance because of the inconvenience and expense.

In the final analysis, a car is a very complex machine that can have unknown, unapparent, underlying damage that will affect drivability, serviceability, and reliability if it has been in an accident or has otherwise not been properly cared for (e.g., infrequent oil changes). For these reasons, buying a used car can be a daunting task for consumers who, usually, do not have the technical expertise to know when a used car is acceptable or is a “lemon.” With such considerations in mind, it will be recognized that consumers should be equipped with quality information regarding the condition of a used car under consideration for purchase, so that they can buy a quality used car that will be reliable and will serve their needs.

### SUMMARY

The present subject matter is intended to empower consumers by enabling them to obtain information relevant to their decision to purchase a used car. Accordingly, the present method, system, and apparatus enables consumers, and/or their mechanics, to inspect used vehicles for damage or other red flag indicators; thereby, providing additional information giving consumers the power to choose a quality used car, rather than choosing a lemon due to a lack of appropriate information.

In one embodiment, a body panel inspection device is used to determine if a vehicle was in an accident. The inspection device uses a magnet with a particular magnetic strength and other characteristics to determine if the vehicle body panel has been damaged and subsequently repaired.

In another embodiment, the body panel inspection device is used in conjunction with other devices, a vehicle inspection sheet, and an instructional video, so that a consumer may be able to better analyze key factors that will help them purchase a quality used car.

### BRIEF DESCRIPTION OF THE DRAWINGS

The following detailed description of preferred embodiments is better understood when read in conjunction with the appended drawings. For the purposes of illustration, there is shown in the drawings exemplary embodiments; however, the subject matter is not limited to the specific elements and instrumentalities disclosed.

FIG. 1A is an exemplary embodiment of a front elevation view of a body panel inspection device;

FIG. 1B is an exemplary embodiment of a front elevation view of a body panel inspection device handle without a magnet or a protective element;

FIG. 1C is an exemplary embodiment of a front elevation view of a body panel inspection device magnet without a handle or a protective element;

FIG. 2 is an exemplary embodiment of a typical vehicle car frame without body panels; and,

FIG. 3 is an exemplary embodiment of a vehicle inspection sheet.

It is to be noted that the drawing Figures presented are intended solely for the purpose of illustration and that they are, therefore, neither desired nor intended to limit the subject matter of the claimed invention to any or all of the exact details of construction shown, except insofar as they may be deemed essential to the claimed invention.

### DETAILED DESCRIPTION OF ILLUSTRATIVE EMBODIMENTS

In describing preferred embodiments of the subject matter of the present invention, as illustrated in the drawing Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

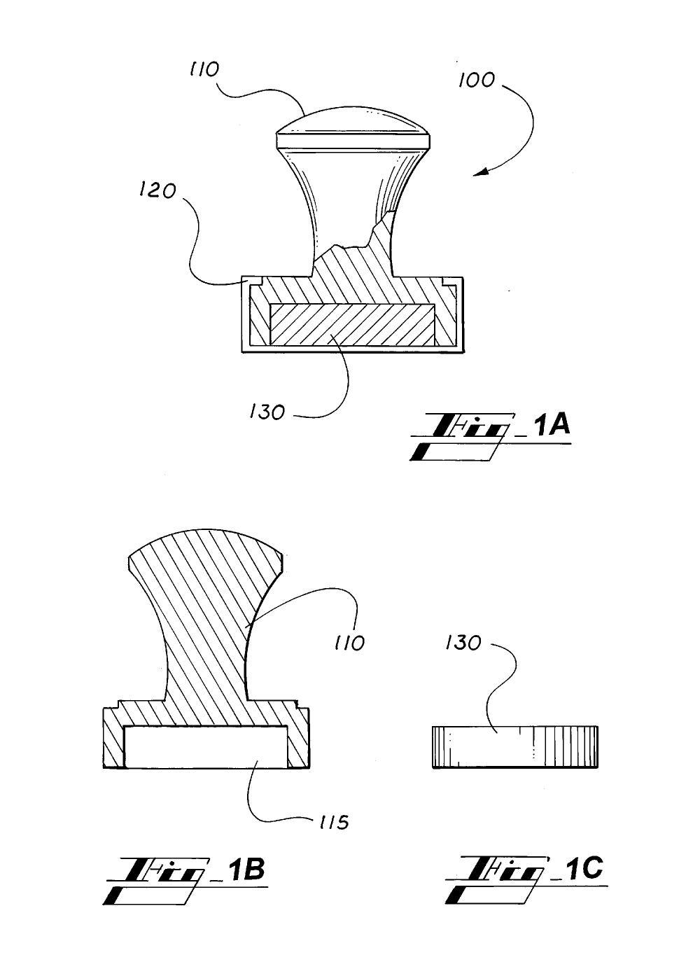

Referring now more particularly to the drawing Figures, and to that embodiment of the invention here presented by way of illustration, FIGS. 1A-1C illustrate one embodiment of vehicle body panel inspection device 100 and its component elements. Inspection device 100 has handle 110 with designed cavity 115 into which magnet 130 can be inserted. Protective rubber material 120 covers the face of magnet 130 and handle 110 that will be in contact with the vehicle. The preferred embodiment of inspection device 100 uses permanent magnet 130 with certain magnetic strength and physical parameters that aid in detecting repaired body damage.

The preferred embodiment has magnet 130 that is a Neodymium 35 (N35) permanent magnet. After studying the relationship of permanent magnets, vehicle body panels and frames, and fillers, inter alia, Applicant determined that a diameter of approximately 9.52 millimeters and a thickness of approximately 7.62 millimeters is well suited to eliminate false indications of lack of non-metallic filler, primer, or other like substances (hereinafter “filler”). An acceptable range of thickness between approximately 6.80-9.40 millimeters, however, has been determined to be acceptably suited to the applications described. It will be recognized that, in other embodiments, an electromagnet can be used to create the same desired effect. In such embodiments, it is recommended that the electromagnet be calibrated so that it has a similar magnet field strength and effective field diameter as the exemplary permanent magnet embodiment.

It is here noted that the above-suggested magnet diameter has been found to be effective in detecting filler-type repairs. In fact, it has been determined that the chosen magnet diameter is an important factor in a user's ability to detect a filler-type repair. This is because when the magnet diameter is too great in relationship to an area under observation, the magnet may span outside the area of filler repair and may, therefore, affix to unrepaired metal body panel portions. It has been determined that a relatively smaller diameter magnet, in conjunction with an effective magnetic field strength, the criteria for which are discussed herein, better serves a user in detecting filler-type body panel repairs.

The preferred embodiment of handle 110 is a nickel plated steel, formed into an ergonomic shape and size by any means of fabrication, but can be any material that will allow magnet 130 to hold inspection device 100 onto unrepaired body panels while at the same time appropriately unfasten when placed on filler material. In other embodiments, handle 110 may be formed by casting, machining, molding, or otherwise, and may be of any shape and size. In some embodiments, handle 110 may carry a brand indicia, such as a trademark or logo. Magnet 130 should be strong enough so that it can hold the weight of the entire inspection device 100 in place when on a painted, metal, non-repaired body panel, but weak enough so that it will not penetrate painted, non-ferrous filler materials.

In one embodiment, magnet 130 can be held in cavity 115 by an epoxy or other adhesive, by an interference fit between magnet 130 and cavity 115, or via any other means that allows magnet 130 to be effectively held within cavity 115. In addition, and as is depicted in a preferred embodiment, it would be advantageous to provide the above-described inspection device 100 with magnetic means for effectively detecting filler, while minimizing a chance that a user might scratch the surface of a vehicle through use of the inspection device. Accordingly, as described herein for such purposes, scratch preventive material 120 is provided in the form of a relatively thin rubber overcovering. In other embodiments, scratch preventive material 120 can be any rubber or non-rubber material that will have minimal reduction of effective field strength of magnet 130 for the uses described herein. For example, inspection device 100 can be dipped in, sprayed, or overcovered with, a liquid rubber, urethane, polymer, or other substance, which would dry or cure, and, thereby, form a coating to prevent inspection device 100 from scratching a vehicle surface.

Notwithstanding the desire to prevent reduction of effective field strength of magnet 130 for the uses described herein through use of scratch preventive material 120, it will be recognized by those of ordinary skill in the art that, if scratch preventive material 120 does have a measurable reduction of effective field strength of the magnet for the uses described, then the field strength of magnet 130 should be increased proportionally in order to regain the desired, effective field strength.

When inspection device 100 is not held into place on a purported original, painted body of a vehicle, then such failure indicates that the vehicle body panel under observation includes other materials at that location, such as, most likely, non-ferrous filler. This, of course, indicates the vehicle body was damaged and subsequently repaired. Thus, disclosed vehicle body inspection device 100 is designed to detect fillers because magnets of the size, nature, and characteristics described hereinabove will not properly hold onto such fillers.

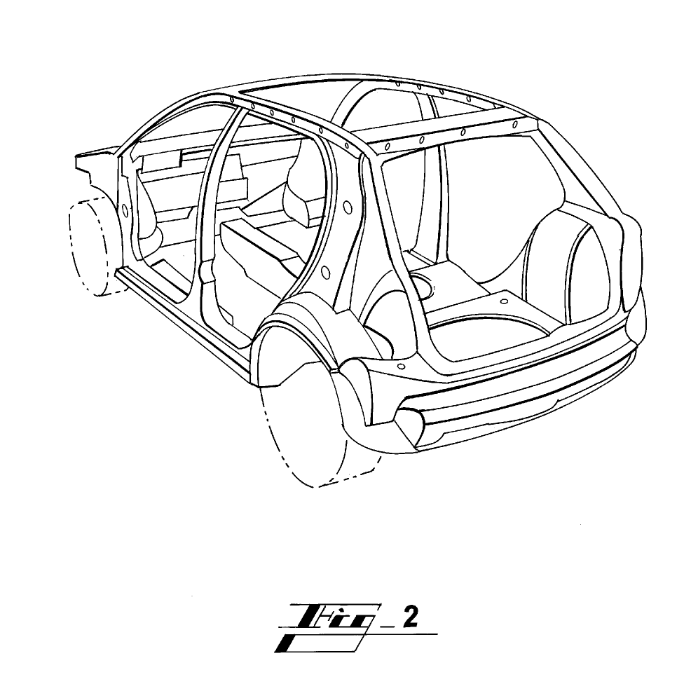

As described above, Applicant discovered that not just any magnet can be used to test for fillers because magnets with incorrect characteristics may often give false indications that a filler is not present when, in fact, a filler is present. FIG. 2 depicts an example of a car body frame. It can be seen that the car body frame is made of metal that will attract magnets. It can also be seen that, if a magnet comprises incorrect characteristics, including size and effective field strength, a false indication of lack of filler may be observed, due to the strength of the magnet. That is to say, a strong magnet has a strong field that will pass through the filler and be attracted to the frame of the vehicle, or to a deeper, underlying portion of the vehicle body panel under observation, rather than to only the repaired surface of the vehicle body panel. Because of the aforementioned reasons, magnets in the prior art are ineffective for examining car body panels for undesirable fillers.

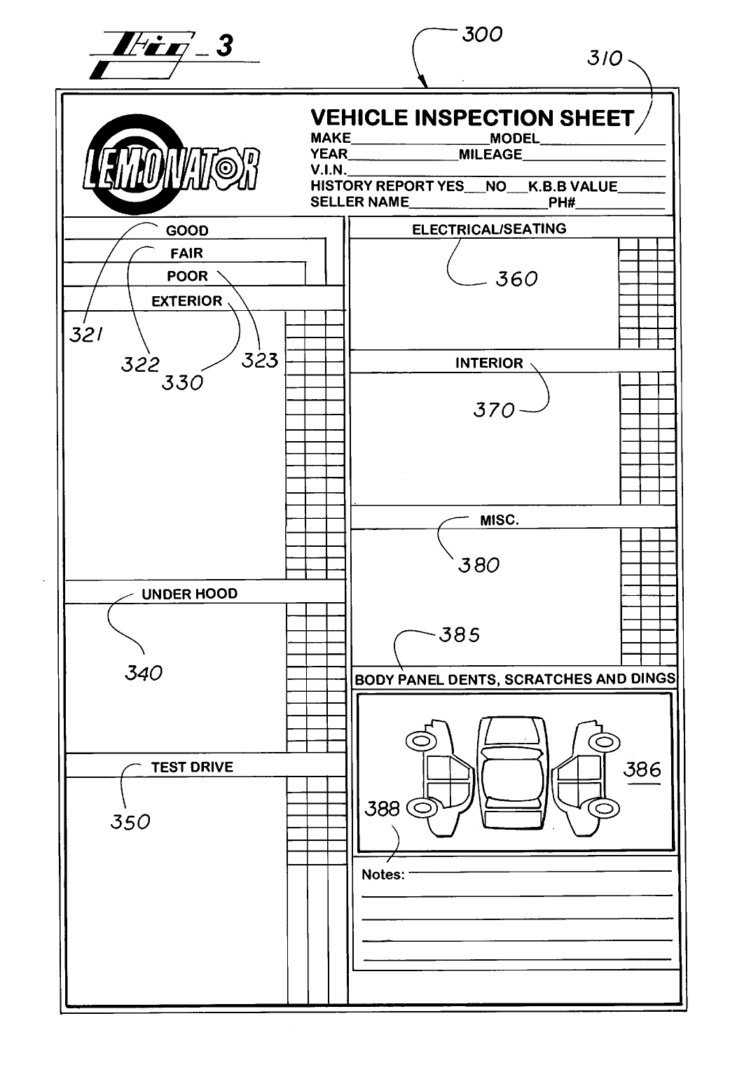

It will be further noted that the preferred embodiment of inspection device 100 is small, so it can be part of a used car inspection kit. Accordingly, one embodiment empowers consumers, mechanics, and other persons who utilize this system to make an informed decision when determining which used car to buy. For example, the consumer may utilize disclosed vehicle body inspection device 100 with an inspection kit. The inspection kit may contain, by way of non-limiting example, a tire tread depth gauge, non-allergenic disposable gloves, an extendable or telescopic inspection mirror, a window tint indicator, vehicle body inspection device 100, one or more inspection towel, flashlight and batteries, a vehicle inspection sheet, and an instructional video teaching inspection techniques and criteria, among other things. The vehicle inspection sheet may look similar to that embodiment depicted in FIG. 3. Vehicle inspection sheet 300 in FIG. 3 has space 310 for vehicle identification and other information. Vehicle inspection sheet 300 has several headings, such as Exterior 330, Under Hood 340, Test Drive 350, Electrical/Seating 360, Interior 370, Misc. Items 380, Body Panel Dents, Scratches, and Dings 385, and Notes 388. Below the referenced headings are subheadings, such as, for example, Front Bumper Condition, Paint Color Match, and Paint on Plastic Trim under Exterior Heading 330. The subheadings are rated by marking the appropriate color-coded box for Good 321, Fair 322, and Poor 323, wherein Good 321 can be colored green, Fair 322 can be colored yellow, and Poor 323 can be colored red.

For example, a consumer may use inspection device 100 while looking at the Body Panel Dents, Scratches, and Dings 385 portion of vehicle inspection sheet 300. Using Body Panel Dents, Scratches, and Dings 385 portion of vehicle inspection sheet 300 as a guide, the consumer can move inspection device 100 across each section of a car, as shown in diagram 386, and make note anytime inspection device 100 is not held in place on the purported original painted area. Every time the inspection device is not held into place, it is an indication that undesirable primers and body fillers have been used to repair a car, most typically after that car has been in an accident. The consumer may use this information in many different ways. By way of non-limiting example, the consumer may use the information to negotiate with the seller for a reduced price, to require the seller to pay for additional, professional inspections or further repairs, to simply walk away from the possible transaction, or the like.

It will be understood that the particular embodiments of the subject matter here presented is by way of illustration only, and is, in no way, meant or intended to be restrictive; therefore, numerous changes and modifications may be made, and the full use of equivalents resorted to, without departing from the spirit or scope of the subject matter as provided in the written description and the appended claims.

1. A vehicle body panel inspection apparatus comprising:
(a.) a handle comprising a first end adapted to be grasped by a user's hand, and a second end comprising a cavity adapted to receive a magnet;
(b.) a magnet adapted to be received within said cavity of said handle;
(c.) at least one face of said magnet being exposed from an open end of said cavity; and
(d.) a scratch preventive material overcovering at least said exposed magnet face and open end of said cavity;
whereby if said inspection device affixes to a vehicle body panel area, a user may presume that a non-ferrous filler material is not present, and whereas, if said inspection device fails to affix to a vehicle body panel area, a user may presume that a non-ferrous filler material is present.

2. The apparatus of claim 1 wherein said magnet comprises a permanent magnet.

3. The apparatus of claim 2 wherein said magnet comprises Neodymium 35.

4. The apparatus of claim 2 wherein said magnet comprises a diameter of approximately 9.5 millimeters.

5. The apparatus of claim 2 wherein said magnet comprises a thickness between approximately 6.80-9.40 millimeters.

6. The apparatus of claim 2 wherein the thickness of said magnet is approximately 7.6 millimeters.

7. The apparatus of claim 1 wherein said magnet comprises an electromagnet.

8. The apparatus of claim 1 wherein said magnet is strong enough to hold the weight of the inspection apparatus in place when on a painted, ferrous metal, non-repaired body panel, but weak enough so that it will not penetrate painted, non-ferrous filler materials.

9. The apparatus of claim 1 wherein said handle is ergonomically shaped for use in the human hand.

10. The apparatus of claim 1 wherein said handle comprises nickel plated steel.

11. The apparatus of claim 1 wherein said handle further comprises an indicia.

12. The apparatus of claim 1 wherein said overcovering is selected from the group consisting of rubber, dip coatings, urethane, polymer, and non-rubber.

13. The apparatus of claim 1 wherein said magnet is held within said cavity by an adhesive.

14. The apparatus of claim 1 wherein said magnet is held within said cavity by interference fit between said magnet and said cavity wall.

15. A vehicle inspection kit comprising:
(a.) a vehicle body panel inspection device comprising a permanent magnet adapted to be affixed within a cavity of an ergonomic handle; at least one face of said magnet being exposed from an open end of said cavity; and a scratch preventive material overcovering at least said exposed magnet face and open end of said cavity; and
(b.) one or more elements selected from the group consisting of:
(1.) a tire tread depth gauge;
(2.) disposable gloves;
(3.) an extendable or telescopic inspection mirror;
(4.) a window tint indicator;
(5.) an inspection towel;
(6.) a flashlight and batteries;
(7.) a vehicle inspection sheet; and
(8.) an instructional video teaching inspection considerations.

16. A method of inspection of a vehicle comprising the steps of:
(a.) testing for non-ferrous filler material within a surface of a vehicle using a vehicle body panel inspection device comprising a permanent magnet adapted to be affixed within a cavity of an ergonomic handle; at least one face of said magnet being exposed from an open end of said cavity; and a scratch preventive material overcovering at least said exposed magnet face and open end of said cavity;
(b.) utilizing a vehicle inspection sheet to guide inspection of one or more of an exterior of the vehicle, the engine compartment of the vehicle, the electrical components of the vehicle, the seating components of the vehicle, the interior of the vehicle, and miscellaneous items associated with the vehicle.

17. The method of claim 16 wherein prior to beginning step (a.), a user reviews an instructional video teaching inspection techniques and criteria.

18. The method of claim 16 wherein step (b.) is aided by use of one or more additional elements selected from the group consisting of a tire tread depth gauge, disposable gloves, an extendable or telescopic inspection mirror, a window tint indicator, an inspection towel, and a flashlight and batteries.

19. The method of claim 16 further comprising step (c.) wherein a user moves said vehicle body panel inspection device across an exterior portion of the vehicle and makes a corresponding location-based notation on a diagram carried by said vehicle inspection sheet anytime said inspection device is not held in place on the exterior portion.

20. The method of claim 16 wherein said inspection sheet comprises a color-coded schema representing a condition of the vehicle corresponding to an inspection criterion.
